(19) United States
(12) Patent Application Publication
(10) Pub. No.: US 2011/0050557 A1
(43) Pub. Date: Mar. 3, 2011

(54) BACKLIGHT UNIT AND DISPLAY APPARATUS INCLUDING THE SAME

(75) Inventors: Hoon Hur, Pyeongtaek-si (KR); Bup Sung Jung, Pyeongtaek-si (KR); Chan Sung Jeong, Pyeongtaek-si (KR)

(73) Assignee: LG Electronics Inc., Seoul (KR)

(21) Appl. No.: 12/728,131

(22) Filed: Mar. 19, 2010

Related U.S. Application Data
(60) Provisional application No. 61/237,841, filed on Aug. 28, 2009.

(30) Foreign Application Priority Data
Aug. 28, 2009 (KR) 10-2009-0080654

(51) Int. Cl. G09G 3/36

(52) U.S. Cl. 345/102

(57) ABSTRACT

A backlight unit may be provided that includes a substrate, light sources, and a light guide plate. The light sources are arrayed on the substrate, and emit light with a predetermined orientation angle with respect to a first direction, and include first through third light sources adjacent to each other. The light guide plate may include a light incident part having a light incident surface to which streaks of light respectively emitted from the light sources are laterally incident, and a light emitting part emitting the incident streaks of light upward and having a side adjacent and connected to the light incident part. A first distance between the first light source and the second light source is less than a second distance between the second light source and third light source.

### CROSS-REFERENCE TO RELATED APPLICATION

The present application claims priority under 35 U.S.C. §119 and 35 U.S.C. §365 to U.S. Provisional Patent Application Ser. No. 61/237,841 filed on Aug. 28, 2009 and Korean Patent Application No. 10-2009-0080654 filed on Aug. 28, 2009, the subject matter of which is hereby incorporated by reference.

### BACKGROUND

1. Field

Embodiments of the present disclosure may relate to a backlight unit and/or a display apparatus that includes a backlight unit.

2. Background

There is a need for diverse forms of display apparatuses. Accordingly, various display apparatuses such as liquid crystal display devices (LCDs), plasma display panels (PDPs), electro luminescent displays (ELDs), and/or vacuum fluorescent displays (VFDs) have become commercialized.

An LCD may have a liquid crystal panel that includes a liquid crystal layer, a thin film transistor (TFT) substrate, and a color filter substrate facing the TFT substrate with the liquid crystal layer therebetween. Such a liquid crystal panel, having no light source, may use light provided by a backlight unit to display an image.

### BRIEF DESCRIPTION OF THE DRAWINGS

Arrangements and embodiments may be described in detail with reference to the following drawings in which like reference numerals refer to like elements and wherein:

FIG. 1 is an exploded perspective view illustrating a display apparatus according to an embodiment;

FIG. 2 is a cross-sectional view taken along line A-A of FIG. 1;

FIG. 3 is an enlarged view illustrating a portion Q of FIG. 2;

FIG. 4 is a schematic view illustrating a rear surface of a display module according to an embodiment;

FIG. 5 is an exploded perspective view illustrating an optical assembly of FIG. 1;

FIG. 6 is a plan view illustrating a backlight unit according to an embodiment;

FIG. 7 is a plan view illustrating a light guide plate and arrayed light sources of FIG. 5;

FIG. 8 is a bottom view illustrating a lower surface of a light guide plate (of FIG. 5);

FIG. 9 is a cross-sectional view taken along line B-B of FIGS. 7 and 8;

FIG. 10 is a graph illustrating density of diffusion optical elements along line B-B of FIGS. 7 and 8;

FIG. 11 is a graph illustrating density of additional optical elements along line C-C of FIGS. 7 and 8L;

FIG. 12 is a graph illustrating a combination of density of diffusion optical elements and density of the additional optical elements along line D-D of FIGS. 7 and 8;

FIG. 13 is a cross-sectional view illustrating a backlight unit according to an embodiment;

FIG. 14 is a perspective view illustrating a light guide plate of FIG. 13;

FIG. 15 is a plan view illustrating a backlight unit according to an embodiment;

FIG. 16 is an enlarged view illustrating a portion S of FIG. 15;

FIG. 17 is a cross-sectional view of a light guide plate according to an embodiment; and

FIG. 18 is a perspective view illustrating a bottom surface of a light guide plate according to an embodiment.

### DETAILED DESCRIPTION

Reference may now be made in detail to arrangements and embodiments, examples of which may be illustrated in the accompanying drawings. The present disclosure may, however, be embodied in many different forms and should not be construed as being limited to the embodiments set forth herein; rather, these embodiments are provided so that this disclosure will be thorough and complete, and will fully convey the concept of the disclosure to those skilled in the art. In the drawings, shapes and sizes of elements may be exaggerated for clarity.

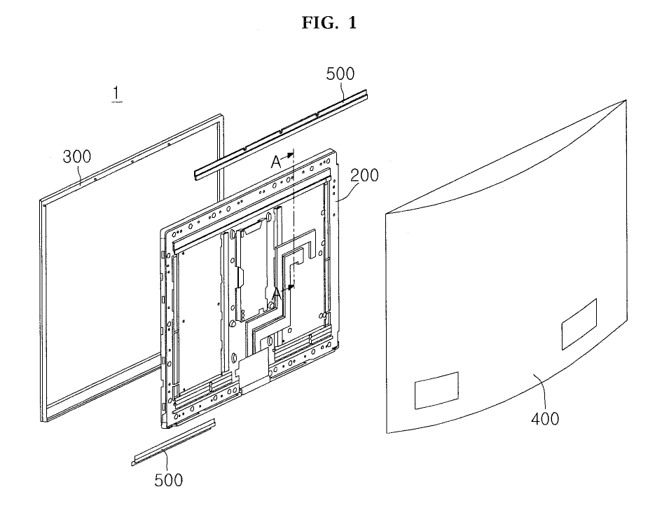

FIG. 1 is an exploded perspective view illustrating a display apparatus 1 according to an embodiment. Other embodiments and configurations may also be provided.

FIG. 1 shows that the display apparatus 1 includes a display module 200, a front cover 300 and a back cover 400 that surround the display module 200 and a fixing member 500 (or attachment member) for fixing or attaching the display module 200 to at least one of the front cover 300 or the back cover 400.

A portion of the fixing member 500 may be fixed to the front cover 300 through a coupling member such as a screw, and another portion of the fixing member 500 may support the display module 200 with respect to the front cover 300 so that the display module 200 can be fixed with respect to the front cover 300.

Although the fixing member 500 is shown as having an elongated plate shape, the display module 200 may be fixed or attached to the front cover 300 or the back cover 400 through a coupling member without the fixing member 500.

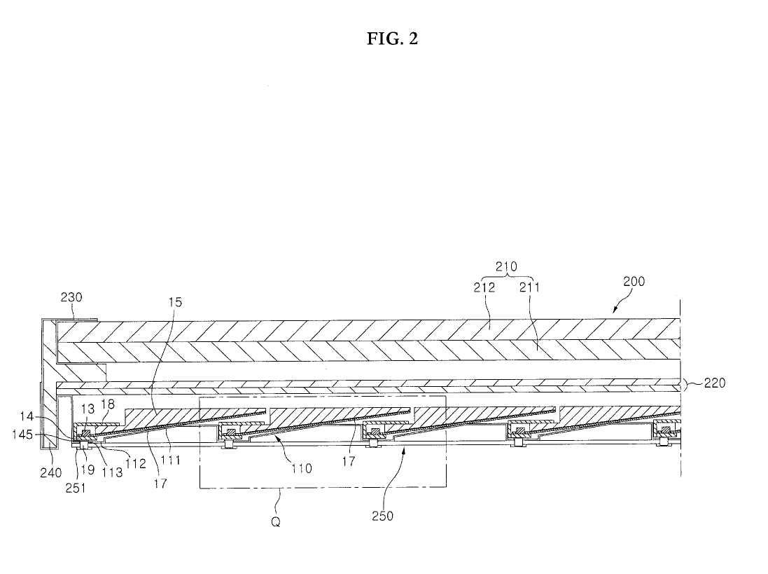

FIG. 2 is a cross-sectional view taken along line A-A of FIG. 1.

As shown in FIG. 2, the display module 200 may include a display panel 210 for displaying an image, a backlight unit 100 to emit light to the display panel 210, a bottom cover 110 providing a lower appearance of the display module 200, a panel supporter 240 supporting the display panel 210 from the lower side, and a top cover 230 supporting the display panel 210 from the upper side and constituting a border of the display module 200.

The bottom cover 110 may have a box shape with an open upper surface to receive the backlight unit 100. A side of the bottom cover 110 may be fixed or attached to a side of the top cover 230. For example, a coupling member such as a screw may pass through a side surface of the display module 200, or more specifically, through a side where the bottom cover 110 overlaps the top cover 230 to fix or attach the bottom cover 110 and the top cover 230.

A rear side of the bottom cover 110 may be provided with at least one driving substrate 250 to drive the display module 200 with a signal transmitted from the outside (e.g. an image signal).

The driving substrate 250 may be, for example, a driving part of an image panel and/or a backlight unit such as a timing controller, a T-con board, a power supply device, or a main printed circuit board (PCB), and may be fixed or attached to the rear surface of the bottom cover 110 through an adhesive member or a coupling member such as a screw.

The display panel 210 may include a lower substrate 211 and an upper substrate 212 attached to each other with a constant cell gap, and a liquid crystal layer may be provided between the lower substrate 211 and the upper substrate 212. The lower substrate 211 may be provided with a plurality of gate lines and a plurality of data lines crossing the gate lines. Thin film transistors (TFTs) may be provided in crossing areas of the gate lines and the data lines.

The upper substrate 212 may be provided with color filters, although the structure of the display panel 210 is not limited thereto. For example, the lower substrate 211 may include color filters as well as TFTs. In addition, the structure of the display panel 210 may vary according to a method of driving the liquid crystal layer.

Although not shown, an edge of the display panel 210 may be provided with a gate driving printed circuit board (PCB) to supply scan signals to the gate lines, and a data driving PCB to supply data signals to the data lines. One of the upper side or the lower side of the display panel 210 may be provided with a polarized light filter (not shown).

The backlight unit 100 may include a plurality of optical assemblies 10 each including a light source 13, a substrate 14, a light guide plate 15, a reflecting member 17, a fixing bracket 18 and an optical sheet 220 provided between the display panel 210 and the optical assemblies 10.

The optical sheet 220 may be removed, although embodiments are not limited thereto. The optical sheet 220 may include at least one of a spread sheet (not shown) or a prism sheet (not shown).

The spread sheet may uniformly spread light emitted from the light guide plate 15, and the spread light may be collected to the display panel 210 through the prism sheet. The prism sheet may include one or more illumination enhancement films and at least one of a horizontal prism sheet or a vertical prism sheet may be selectively provided. The types and number of optical sheets may vary.

The optical assemblies 10 may be provided under the display panel 210 and the optical sheet 220 to emit light upward to the display panel 210.

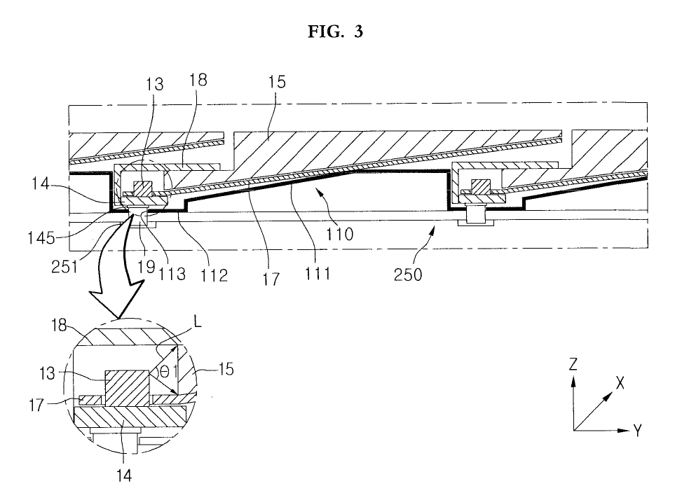

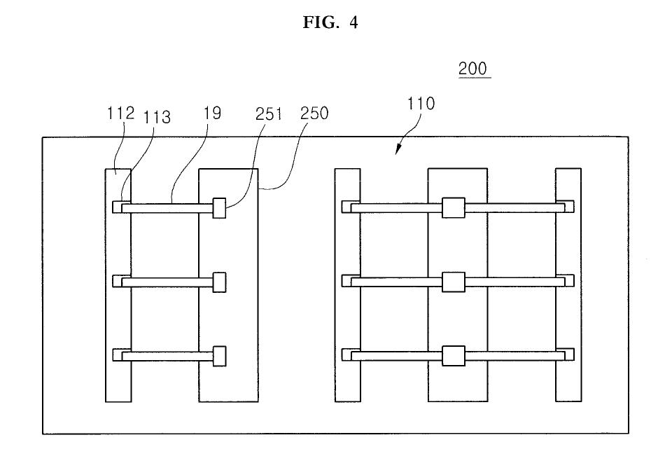

FIG. 3 is an enlarged view illustrating a portion Q of FIG. 2. FIG. 4 is a schematic view illustrating a rear surface of the display module 200.

As shown in FIGS. 3 and 4, the display apparatus 1 may include at least one cable 19 that connects the substrate 14 to the driving substrate 250 to supply a driving signal or power to the substrate 14.

For example, the cable 19 may be a flexible flat cable (FFC). A first end of the cable 19 may be connected to a connector 145 provided to the lower surface of the substrate 14, and a second end of the cable 19 may be connected to a connection part 251 of the driving substrate 250.

The bottom cover 110 may be provided with assembly fixing parts 112 for fixing or attaching the optical assemblies 10. Protrusions 111, protruding to the front side of the display module 200, may be adjacent to the optical assemblies 10 and have shapes corresponding to the light guide panels 15 of the optical assemblies 10.

The protrusions 111 may be inclined at a predetermined angle, corresponding to a lower surface of the light guide plate 15, which is inclined upward at a predetermined angle. The protrusions 111 may be recessed a predetermined depth forward from the rear surface of the bottom cover 110.

The bottom cover 110 may be provided with at least one hole 113 through which the cable 19 passes. The hole 113 may be provided at the assembly fixing part 112.

When a plurality of holes 113 are provided, the holes 113 may be arrayed at positions where the respective optical assemblies 10 connected with the cables 19 are provided at the bottom cover 110.

That is, the holes 113 may be arrayed in an up-and-down direction of the bottom cover 110 on the basis of FIG. 4.

The driving substrate 250 connected to the second end of the cable 19 may be provided in the rear portion of the bottom cover 110, and may extend in the up-and-down direction in which the holes 113 are arrayed.

A configuration of the optical assembly 10 may now be further described.

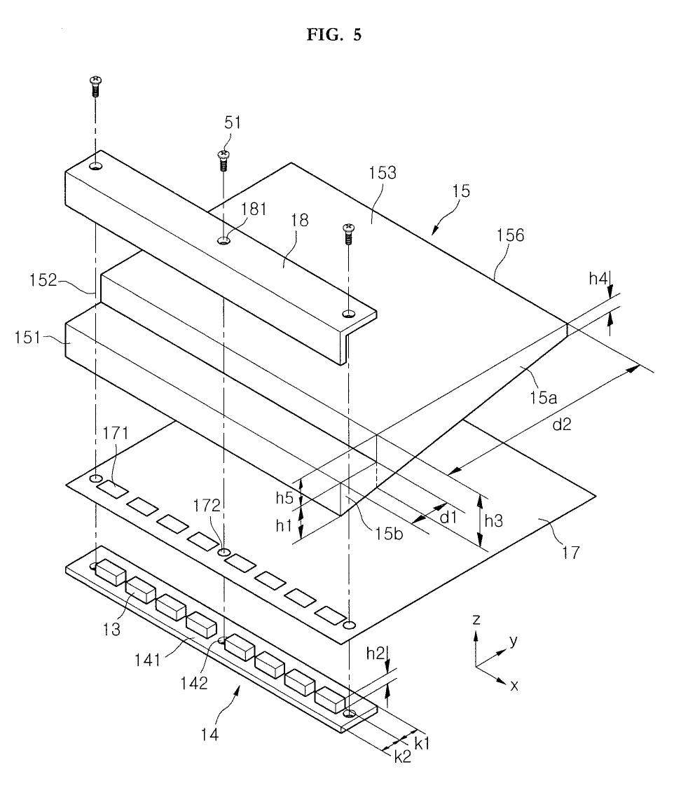

FIG. 5 is an exploded perspective view illustrating the optical assembly 10.

The optical assemblies 10 may be arrayed with at least one portion fixed or attached to the bottom cover 110, and each of the optical assemblies 10 may include the light source 13, the substrate 14, the light guide plate 15, the reflecting member 17 and the fixing bracket 18.

A plurality of light sources 13 may be provided. The light sources 13 may be provided in a left-and-right direction (x-axis direction) at a side surface of the light guide plate 15. Thus, light emitted from the light sources 13 may be incident to the side surface of the light guide plate 15.

The light sources 13 may include a plurality of light emitting diodes (LED).

The LED may be a side illumination-type LED that is configured to laterally emit light.

The LEDs may be provided on the upper surface of the substrate 14, and may emit light having a wavelength ranging from about 430 nm to 480 nm. A fluorescent material may be applied on a light emitting surface of the LED to transmit light emitted from the LED.

Referring FIGS. 3 and 5, also the LEDs may emit light (L) for example, with an predetermined orientation angle (Φ) of about 90° or greater with respect to a first direction (y-axis direction).

The color LED may include at least one of a red LED, a blue LED, and a green LED, and the arrangement and light type of the LEDs may vary.

The light sources 13 may be mounted to a substrate body 141 of the substrate 14 longitudinally extending in the left-and-right direction (x-axis direction), and provided on the rear side of the substrate body 141 in a back-and-forth direction (y-axis direction).

The back-and-forth direction (y-axis direction) may hereafter be referred to as the first direction, and the upward direction (z-axis direction) may hereafter be referred to as a second direction, and the left-and-right direction (x-axis direction) may hereafter be referred to as a third direction.

The light sources 13 may be mounted to a rear area k2 of the substrate body 141 in the back-and-forth direction, a front area k1 may be provided in front of the rear area k2, and the front area k1 may be greater than the rear area k2.

The front area k1 may have a support space with a predetermined size for supporting at least one of the light guide plate 15 and at least one of the reflecting member 17. In addition, as the size of the rear area k2, having just a width for mounting the light sources 13, is decreased, a bezel area of the display module 200 where the rear area k2 may be provided (i.e., the width of the border of the display module 200 may decrease). Accordingly, the width of the rear area k2 may be minimized.

The forward direction of the back-and-forth direction (y-axis direction) may be the direction (+y-axis direction) of light emitted from the light sources 13, and the rearward direction thereof may be the opposite direction (−y-axis direction) to the forward direction.

The first direction (y-axis direction) and the third direction (x-axis direction) may be perpendicular to each other. The substrate 14 may extend in the third direction, and the light sources 13 may be arrayed in the third direction on the substrate 14.

The substrate body 141 may include through holes 142 through which coupling members 51 pass. The through holes 142 may be provided between the light sources 13. The through holes 142 may be provided in the left and right sides of the substrate body 141 and in the middle of the substrate body 141 with the four light sources 13 on each lateral side of the middle.

The coupling members 51 may pass through the fixing bracket 18, the reflecting member 17 and the substrate 14 to coordinate the configuration of the optical assembly 10 and to fix or attach the optical assembly 10 to the bottom cover 110.

The light guide plate 15 may be transparent. For example, the light guide plate 15 may be formed of one of acryl-based resin such as polymethyl methacrylate (PMMA), polyethylene terephthlate (PET), poly carbonate (PC), and polyethylene naphthalate (PEN). The light guide plate 15 may be formed using an extrusion molding method.

The light guide plate 15 may diffuse light emitted from the light source 13 to guide the light upward.

More particularly, light incident forward (y-axis direction) from the light source 13 (i.e., laterally from the light source 13) may be refracted and diffused upward in the second direction (z-axis direction), (i.e., to the display panel 210) by the light guide plate 15. The lower surface of the light guide plate 15 may be inclined upward in the forward direction to efficiently emit laterally incident light upward.

At least one of the lower surface of the light guide plate 15 may be placed on and supported by the front area k1 of the substrate body 141.

The light guide plate 15 may include a light incident part 15b having a light incident surface 151 facing the light source 13, and a light emitting part 15a extending forward from the light incident part 15b.

The rear side of the light guide plate 15 where the light incident surface 151 is provided may be referred to as a first side, and a front end 156 of the light guide plate 15 may be referred to as a second side.

A plurality of streaks of light incident from the light sources 13 into the light guide plate 15 through the light incident surface 151 may be mixed into a single streak of light through the light incident part 15b, and then the single streak of light may be spread through the light emitting part 15a and emitted to the upper side of the light guide plate 15.

A first side of the light emitting part 15a may be connected to a second side of the light incident part 15b. Light mixed in the light incident part 15b may be emitted upward (i.e., through an upper surface 153 of the light emitting part 15a).

A vertical height h2 of a light emitting surface of the light source 13 emitting light may be substantially equal to or less than a vertical height h1 of the light incident surface 151 of the light incident part 15b.

When the height h2 of the light sources 13 is greater than the vertical height h1 of the light incident surface 151, a portion of light emitted from the light emitting surfaces of the light sources 13 may not be incident to the light incident surface 151, but may be leaked out.

Since the light sources 13 emit light, for example, with an predetermined orientation angle of about 90° or greater with respect to the first direction, the height h1 of the light incident surface 151 may be greater than the height h2 of the light sources 13.

However, when the height h1 of the light incident surface 151 is greater than two times the height h2 of the light sources 13, light leak prevention and light efficiency increase may not be achieved. Rather, excessive light diffusion may decrease light efficiency.

Thus, the height h1 of the light incident surface 151 may be equal to the height h2 of the light sources 13, or the height h1 may be less than two times the height h2 of the light sources 13.

The light incident part 15b may extend a predetermined distance (d1) in the forward direction (y-axis direction), and the light emitting part 15a may extend a predetermined distance d2 in the forward direction from the light incident part 15b. Thus, the back-and-forth length of the light guide plate 15 including the light incident part 15b and the light emitting part 15a may be equal to a sum d3 of the back-and-forth lengths of the light incident part 15b and the light emitting part 15a.

A portion connecting the light incident part 15b to the light emitting part 15a may include a raised portion (or step part) due to height difference between an upper surface 152 of the light incident part 15b and the upper surface 153 of the light emitting part 15a.

The height of the upper surface 152 of the light incident part 15b may be less than the height of the upper surface 153 of the light emitting part 15a so that the raised portion (or stair part) has a height h5.

At least one fixing bracket 18 may be in contact with the upper surface 152 of the light incident part 15b to press the upper surface 152 of the light incident part 15b downward (i.e., to the substrate body 141 and the bottom cover 110) so as to firmly fix or attach the light guide plate 15 to the bottom cover 110.

The height h5 of the raised portion (or stair part) may be greater than or equal to a height h4 of the front end (also referred to as second end) 156 of the light incident part 15b.

As described above, the lower surface of the light guide plate 15 may be inclined upward from the light incident part 15b to the light emitting part 15a.

The thickness of the light guide plate 15 may gradually decrease from the light incident part 15b to the light emitting part 15a.

When the height h4 of the second end 156 is greater than the height h5 of the raised portion (or stair part), the inclination angle of the lower surface of the light guide plate 15 may be decreased. This may reduce reflectance of the light guide plate 15, thus decreasing the upward light emitting efficiency of the light emitting part 15a.

In addition, light interference may occur in which light that does not pass through the upper surface 153 of the light emitting part 15a may be leaked into the adjacent light guide plate 15 through the second end 156. Thus, the height h4 of the second end 156 of the light emitting part 15a may be less than or equal to the height h5 of the raised portion (or stair part).

When the height h1 of the light incident surface 151 is less than the height h5 of the raised portion (or stair part), light traveling from the light incident part 15b to the light emitting part 15a may be excessively diffused, so that a dark region is generated on the first side of the light emitting part 15a contacting the light incident part 15b. Thus, the height h1 of the light incident surface 151 may be greater than or equal to the height h5 of the raised portion (or stair part).

From the relationship between the height h1 of the light incident surface 151 and the height h5 of the raised portion (or stair part), and from the relationship between the height h5 of the raised portion (or stair part) and the height h4 of the second end 156 of the light emitting part 15a, the height h1 of the light incident surface 151 may be equal to or greater than the height h4 of the second end 156.

The vertical height h1 of the light incident surface 151 of the light incident part 15b may be less than a vertical height h3 of a first end of the light emitting part 15a connected to the light incident part 15b.

Thus, in the state where streaks of light incident from the light sources 13 into the light guide plate 15 through the light incident part 15b are mixed into a single streak of light, when the single streak of light travels to the first end of the light emitting part 15a having the greater cross section than that of the light incident surface 151, the single streak of light may be spread more widely.

The vertical height h4 of the front end 156 of the light emitting part 15a may be less than the vertical height h1 of the light incident surface 151 of the light incident part 15b, and less than the vertical height h3 of the first end of the light emitting part 15a.

Thus, the vertical cross section of the light emitting part 15a of the light guide plate 15 where light incident through the light incident surface 151 is emitted upward may be decreased, so as to improve upward emission of light.

The lower surface of the light guide plate 15 may be provided with the reflecting member 17 configured to reflect light upward.

The reflecting member 17 may include a reflecting sheet having a predetermined reflectance or greater. A portion of the reflecting member 17 contacting the lower surface of the light guide plate 15 may be greater than the lower surface of the light guide plate 15 in left-and-right width and back-and-forth width.

The reflecting member 17 may be greater in area than the lower surface of the light guide plate 15. Thus, when the light guide plate 15 is provided to the lower surface of the light guide plate 15, the light guide plate 15 may protrude from the left, right and front sides of the light guide plate 15.

Fixing holes 171, through which the light sources 13 respectively pass, may be provided in one side of the reflecting member 17 (i.e., on the rear side of the light guide plate 15) to fix or attach the reflecting member 17 to the substrate 14. The fixing holes 171, passing through the reflecting member 17, may have sizes corresponding to the light sources 13. Through holes 172 may be provided between the fixing holes 171 at positions corresponding to the through holes 142 of the substrate 14.

The fixing bracket 18 may be provided at the first side of the light guide plate 15 (i.e., at the upper surface of the light incident part 15b) so as to fix or attach the light guide plate 15 to the bottom cover 110. The fixing bracket 18 may press at least one portion of the light guide plate 15 to the bottom cover 110 to fix or attach the light guide plate 15.

The fixing bracket 18 may be a cover member that covers at least one portion of the light incident part 15b. The fixing bracket 18 may also be referred to as an attachment member.

The fixing bracket 18 may include a frame structure with a bent upper portion, and may be formed of synthetic resin through injection molding, or of metal. The bent upper portion of the fixing bracket 18 may be provided with through holes 181 through which the coupling members 51 pass.

When the fixing bracket 18 is fixed or attached to the bottom cover 110 through the coupling members 51, the light sources 13 may be provided in the fixing bracket 18, thus preventing light from being emitted from the light source 13 to the outside without passing through the light guide plate 15.

When a first one of the optical assemblies 10 is adjacent to a second one of the optical assemblies 10, at least one portion of the light guide plate 15 of the first optical assembly 10 may overlap, from the upper side, the fixing bracket 18 of the second optical assembly 10.

That is, at least one portion of the light emitting part 15a of the optical assembly 10 may be provided above the fixing bracket 18 and the light incident part 15b of the adjacent optical assembly 10 so that the optical assemblies 10 overlap each other.

The display panel 210 may have a plurality of division areas corresponding to the light guide plates 15. The intensity of light emitted from the light guide plate 15 of the optical assembly 10 (i.e., the brightness of light emitted from the light guide plate 15) may be adjusted according to a gray peak value or a color coordinate signal of the corresponding division area so as to adjust the brightness of the display panel 210.

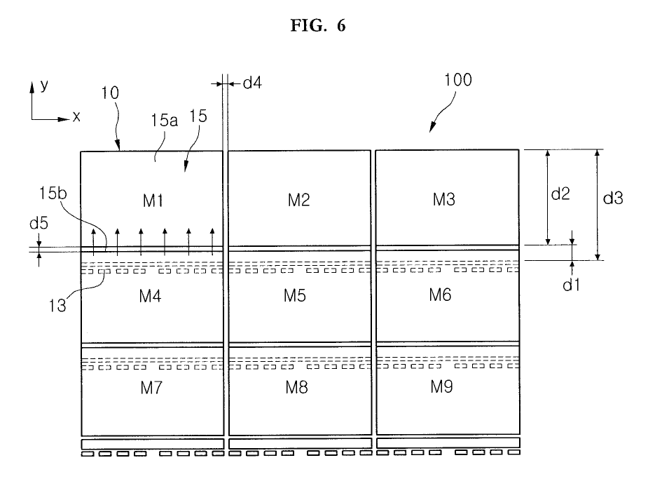

FIG. 6 is a plan view illustrating the backlight unit 100.

In FIG. 6, the fixing bracket 18 for fixing or attaching the light guide plate 15 to the bottom cover 110 is omitted.

As shown in FIG. 6, the optical assemblies 10 of the backlight unit 100 may be arrayed in an N×M matrix, where N is the number of rows arrayed along the y-axis direction, M is the number of columns arrayed along the x-axis direction, and M and N are natural numbers equal to 2 or greater. Each of the optical assemblies 10 may include the light sources 13 and the light guide plate 15.

For example, the number of rows of the light guide plates 15 arrayed along the y-axis direction is N, where N is 2 or greater. The second end 156 of the light emitting part 15a of the light guide plate 15 in a K^{th} row (K is one of 1 to N−1) of the N rows may be provided above the light incident part 15b of the light guide plate 15 in a K+1^{th} row so that the two adjacent light guide plates 15 can overlap each other in at least one portion.

The number of the light guide plate 15 arrayed in the longitudinal direction of the substrate 14 (i.e., the x-axis direction) may be M.

Although the single substrate 14 corresponds to the single light guide plate 15, the substrate 14 may correspond to the light guide plates 15.

Each of the optical assemblies 10 may be driven in an edge-type backlight manner and operate as a single light source. In this state, the optical assemblies 10 may be arrayed in a direct-type backlight manner to constitute the backlight unit 100. Thus, the case that the LEDs are detected as a hot spot on a screen may be prevented, and thickness of the light guide plate 15 and number of optical films may be reduced to achieve slimness of the backlight unit 100.

For example, the backlight unit 100 may include the nine optical assemblies 10 (M1 to M9) in a 3×3 matrix as shown in FIG. 6, although embodiments are not limited thereto. Thus, the matrix of the optical assemblies 10 may vary according to a screen size of a display apparatus.

In the current embodiment, the back-and-forth length (y-axis direction) of the light guide plate 15 is less than the left-and-right length (x-axis direction) in which the light sources 13 are arrayed.

Each of the optical assemblies 10 may be manufactured as a discrete assembly, and the optical assemblies 10 may be adjacent to each other to constitute a module-type backlight unit that is a backlight member configured to provide light to the display panel 210.

The backlight unit 100 may be driven using an entire driving method or a local driving method such as a local dimming method and an impulsive method. The method of driving the LEDs may vary according to a circuit design, although embodiments are not limited. A color contrast ratio may increase, and a bright region and a dark region may be sharply expressed on a screen, thereby improving image quality.

The backlight unit 100 may operate by a plurality of division driving areas corresponding to the light guide plates 15, and brightness of the division driving area may be linked with brightness corresponding to an image signal. Thus, the brightness in a dark portion of an image may decrease, and the brightness in a bright portion of the image may increase so as to improve a contrast ratio and sharpness of the image.

For example, a portion of the optical assemblies 10 (M1 to M9) may be independently driven to emit light. The light sources 13 respectively of the optical assemblies 10 may be independently controlled.

An area of the display panel 210 corresponding to one of the optical assemblies 10 or one of the light guide plates 15 may be divided into two or more blocks, and the display panel 210 and the backlight unit 100 may be dividedly driven in a block unit.

The optical assemblies 10 may be spaced predetermined distances d4 and d5 from each other as shown in FIG. 6. For example, the light guide plates 15 adjacent in the left-and-right direction (x-axis direction) may be spaced the distance d4 from each other, and the light guide plates 15 adjacent in the back-and-forth direction (y-axis direction) may be spaced the distance d5 from each other.

That is, in the state where edges of the light guide plates 15 of the adjacent optical assemblies 10 are in contact with each other and when light emitted from the light sources 13 thermally expands the light guide plates 15, the light guide plates 15 may be out of the coordinated positions, and/or may be deformed by contact stress therebetween.

When the edges of the light guide plates 15 are in contact with each other, luminance of the edges having a high light emittance may be greater than the luminance of the rest of the light guide plates 15. Thus, a mesh of bright lines corresponding to the edges of the light guide plates 15 may occur on a display screen.

Thus, the adjacent optical assemblies 10 may be spaced the distance d4 in the left-and-right direction (x-axis direction) and the distance d5 in the back-and-forth direction (y-axis direction) from each other so as to space the edges of the adjacent optical assemblies 10 apart from each other.

When the distances d4 and d5 are excessively increased, luminance of the distances d4 and d5 may be less than that of the rest of the light guide plate 15. Thus, distances d4 and d5 between the light guide plates 15 may be within a predetermined range.

Accordingly, the lateral distance d4 of the light guide plate 15 may range from about 0.1 to 5 mm, and the longitudinal distance d5 of the light guide plate 15 may range from about 0.1 to 7 mm.

In this case, since the distance between the front edge of the light guide plate 15 and the light sources 13 is greater than the distance between the left edge or the right edge of the light guide plate 15 and the light sources 13, luminance of the front edge may be less than luminance of the left and right edges.

The distance d5 of the light guide plate 15 may be equal to or less than the distance d4.

Additional optical element regions and a diffusion optical element region may be provided on the lower surface (hereafter denoted 154) of the light guide plate 15. The diffusion optical element region may be provided with a plurality of optical elements 155 (FIG. 9) that diffuse light emitted from the light sources 13 to guide the light upward. The optical elements may be protrusions, recesses, scattering mechanisms or dimples, for example. The optical elements may also be considered patterns. FIG. 9 shows protrusions as the optical elements.

A configuration of the optical elements 155, the diffusion optical element region and the additional optical element regions may now be described.

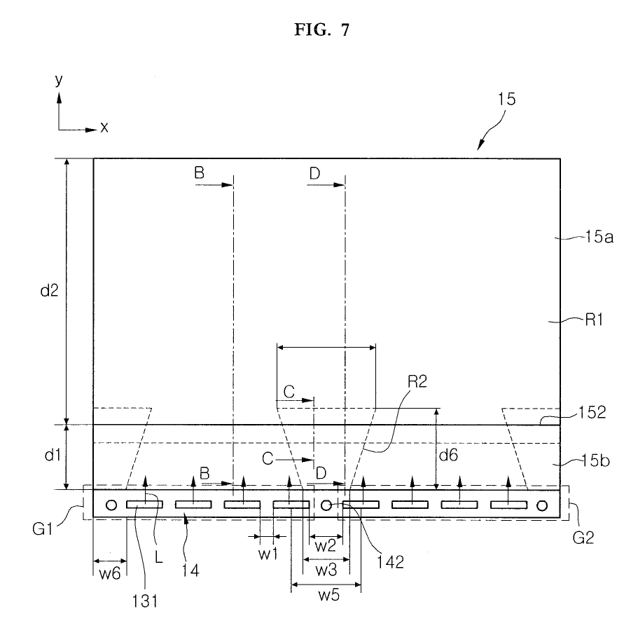

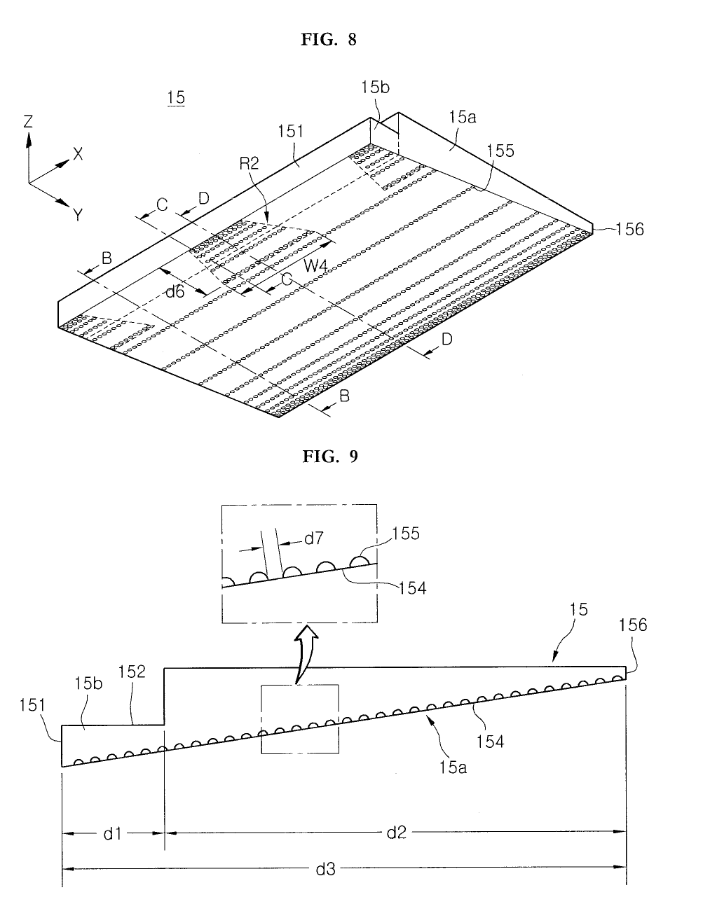

FIG. 7 is a plan view illustrating the light guide plate 15 of FIG. 5, and the arrayed light sources 13 of FIG. 5. FIG. 8 is a bottom view illustrating the lower surface 154 of the light guide plate 15 of FIG. 5. FIG. 9 is a cross-sectional view taken along line B-B of FIGS. 7 and 8. Other embodiments and configurations may also be provided.

In FIG. 7, only the light guide plate 15 and the light sources 13 are shown, and structures such as the fixing bracket 18 are omitted.

Referring to FIGS. 7 and 8, at least one portion of the light guide plate 15 is provided on the front area k1 of the substrate 14.

The light sources 13 may be arrayed in the left-and-right direction (x-axis direction) and mounted or provided to the substrate 14 as described above.

More particularly, the light sources 13 may be spaced a first distance w1 and a second distance w2, which is greater than the first distance w1, from each other, so as to emit light rays L to the light incident part 15b.

The through hole 142 may be provided in a region corresponding to the second distance w2. A first light source group G1 and a second light source group G2 may each includes the four light sources 13 that are spaced the first distance w1 from each other. The first light source group G1 is spaced from the second light source group G2 by the second distance w2.

A light source group of one of the optical assemblies 10 may be spaced the second distance w2 from a light source group of the adjacent optical assembly 10.

When the second distance w2 between the first light source group G1 and the second light source group G2 is different from the first distance w1 between the light sources 13 in one of the first light group G1 or the second light source group G2, light spread may be uneven in the light guide plate 15.

Thus, the light guide plate 15 may include the diffusion optical element region (hereafter denoted R1) and the additional optical element regions (hereafter denoted R2) that partially overlap the diffusion optical element region R1 so as to make light spread uniform.

Referring to FIGS. 7 to 9, the lower surface 154 of the light guide plate 15 may include the diffusion optical element region R1 and the additional optical element regions R2 so as to efficiently emit light, incident to the light guide plate 15, to the upper side of the light guide plate 15.

The lower surface 154 of the light guide plate 15 may be provided with the optical elements 155, such as protrusions and/or recesses. For example, the optical elements 155 may be formed in relief or intaglio on the lower surface 154 of the light guide plate 15.

The optical elements 155 may be formed in relief or intaglio on the lower surface 154 through a process such as a laser cutting process.

For example, the optical elements 155 may have dimple shapes or line shapes extending in the left-and-right direction of the light guide plate 15. The optical elements 155 may be spaced a distance d7 from each other. The density of the optical elements 155 provided to the lower surface 154 may be controlled by adjusting the distance d7.

The optical elements 155 may improve light diffusion for emitting light upward from the light guide plate 15, thus minimizing optical loss and increasing luminance of the light guide plate 15.

As the density of the optical elements 155 increases, light diffusion may be improved.

The density of the optical elements 155 may denote a number or distances of the optical elements 155 per a unit area of the lower surface of the light guide plate 15.

Thus, when one portion of the light guide plate 15 is different from another portion thereof in luminance and the amount of light, the density of the optical elements 155 may be adjusted to make the entire luminance of the light guide plate 15 uniform.

Although the optical elements 155 may be formed in relief or intaglio directly on the lower surface 154, the optical elements 155 may be provided to the lower surface 154 through printing or deposition, or a discrete pattern sheet including the optical elements 155 may be provided to the lower surface 154.

The lower surface 154 may include the diffusion optical element region R1 and the additional optical element regions R2 that divide a region provided with the optical elements 155.

The diffusion optical element region R1 and the diffusion optical element region R2 may be provided on the lower surface 154 of the light guide plate 15, and more particularly in the region of the lower surface 154 adjacent to the light emitting part 15a.

For example, the diffusion optical element region R1 may be the entire region of the lower surface 154 of the light guide plate 15. The diffusion optical element region R1 may range, e.g., from the rear edge of the light guide plate 15, that is, from the rear edge where the light incident surface 151 of the light incident part 15b is provided to the front edge of the light guide plate 15.

Although the diffusion optical element region R1 may be the entire region of the lower surface 154, the diffusion optical element region R1 may be provided to only one portion of the lower surface 154 where the light emitting part 15a substantially emitting light upward is provided.

The optical elements 155 provided to the diffusion optical element region R1 may be referred to as diffusion optical elements (or patterns). The density of the optical elements 155 provided to the diffusion optical element region R1 may increase from the rear side of the light guide plate 15 to the front side thereof.

Light emitted from the light sources 13 spaced the second distance w2 may be greater in area per light intensity than light emitted from the light sources 13 spaced the first distance w1. Thus, the region of the light guide plate 15 adjacent to the region corresponding to the second distance w2 may have a low luminance value.

The lower surface 154 of the light guide plate 15 contacting the region corresponding to the second distance w2 may be provided with the diffusion optical element region R2 that overlaps at least a portion of the diffusion optical element region R1.

The additional optical element regions R2 may be provided to the left end, right end and middle of the light guide plate 15. The additional optical element regions R2 provided to the left end and the right end of the light guide plate 15 may have shapes that are formed by removing a portion from the diffusion optical element region R2 provided to the middle of the light guide plate 15.

The diffusion optical element region R2 provided in the middle of the light guide plate 15 may now be further described.

The diffusion optical element region R2 may extend along a distance d6 from the rear edge of the lower surface 154 to the front side of the light guide plate 15. The distance d6 along which the additional optical element regions R2 extends may be equal to or greater than the distance d1 along which the light incident part 15b extends, and may be less than the sum d3 along which the light guide plate 15 extends.

In the same manner of the diffusion optical element region R1, the optical elements 155 may be provided in the additional optical element regions R2. The optical elements 155 provided in the additional optical element regions R2 may be referred to as additional optical elements (or additional patterns).

That is, when the diffusion optical element region R1 overlaps at least one portion of the diffusion optical element region R2, the density of the optical elements 155 provided in the overlapped portion may be equal to a sum of the density of the diffusion optical elements of the diffusion optical element region R1 and the density of the additional optical elements of the diffusion optical element region R2.

A width w3 in the left-and-right direction at the rear end of the diffusion optical element region R2 (i.e., at the portion adjacent to the light sources 13) may be equal to or greater than the second distance w2, and may be equal to or less than a distance w5 between centers of the two light sources 13 provided symmetrically with respect to the second distance w2.

The width w3 of the diffusion optical element region R2 may denote a width of the diffusion optical element region R2 provided in the third direction.

The diffusion optical element region R2 may increase in left-and-right width to the front side (i.e., in the first direction). A left-and-right width w4 of the front end of the diffusion optical element region R2 (i.e., of the portion of the diffusion optical element region R2 farthest from the light sources 13) may be equal to or greater than the distance w5 provided between the centers of the two light sources 13.

That is, the diffusion optical element region R2 may have a trapezoid shape that increases in width (in the third direction) from the rear side to the front side (i.e., in the first direction). The width of the portion of the diffusion optical element region R2 adjacent to the light sources 13 may be equal to or greater than the second distance w2 between the light sources 13.

When the width w3 of the portion of the diffusion optical element region R2 nearest to the light sources 13 is extremely decreased to a point, the diffusion optical element region R2 may have a triangle shape that increases in left-and-right width from the rear side to the front side.

The density of the additional optical elements provided in the diffusion optical element region R2 may increase from the rear end (corresponding to the width w3) to the front side.

Density variations of the diffusion optical elements and the additional optical elements respectively provided to the diffusion optical element region R1 and the diffusion optical element region R2 may now be described.

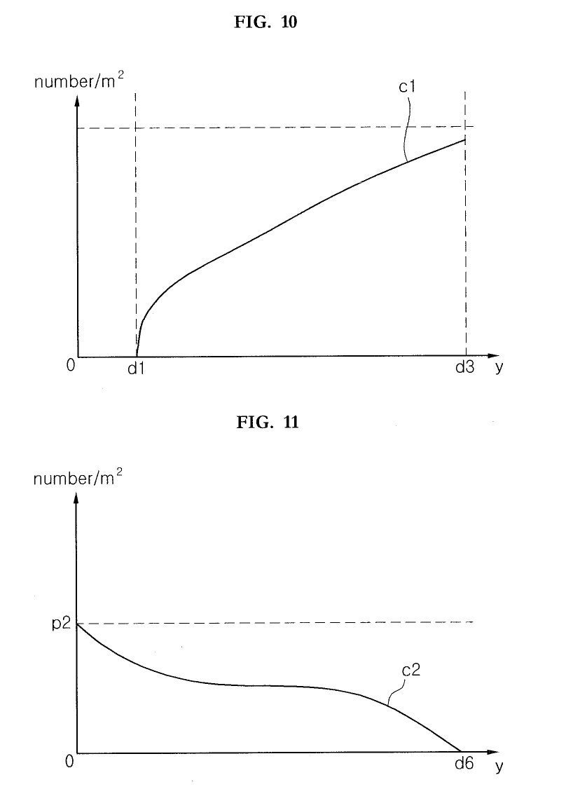

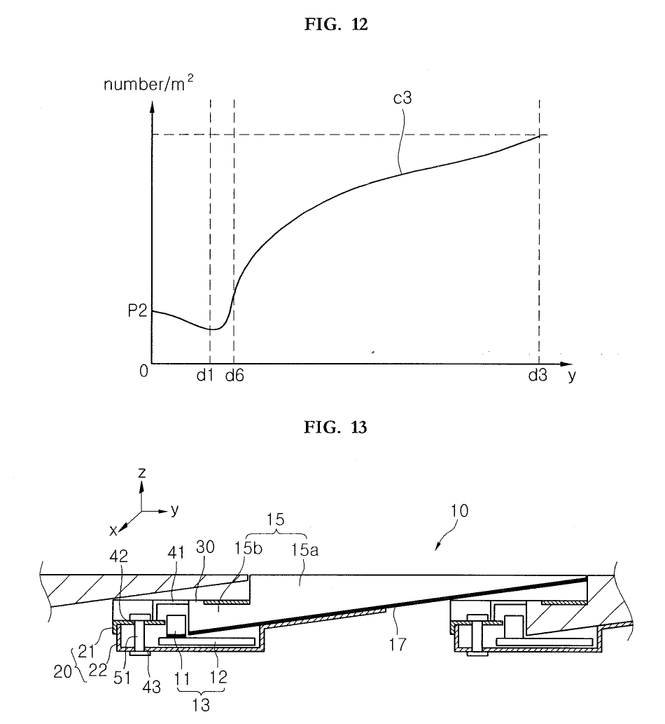

FIG. 10 is a graph illustrating density of the diffusion optical elements along line B-B of FIGS. 7 and 8. FIG. 11 is a graph illustrating density of additional optical elements along line C-C of FIGS. 7 and 8. FIG. 12 is a graph illustrating a combination of density of the diffusion optical elements and density of the additional optical elements along line D-D of FIGS. 7 and 8.

FIG. 10 is a graph illustrating optical element density in a region provided with only diffusion optical element region R1, and FIG. 12 is a graph illustrating optical element density in a region provided with diffusion optical element region R1 and diffusion optical element region R2.

Referring to FIGS. 7, 8 and 10, a diffusion optical element density distribution curve C1 of the diffusion optical elements provided to the diffusion optical element region R1 may gradually increase from the rear edge of the lower surface 154, and may sharply increase in slope at a position where the light incident part 15b is in contact with the light emitting part 15a along the distance d1.

This is because the light emitting part 15a substantially emits light to the upper side of the light guide plate 15, and thus increase in light diffusion efficiency may be required at the light emitting part 15a.

The diffusion optical element density distribution curve C1 may become a non-linear curve that gradually decreases in slope, and the diffusion optical element density distribution curve C1 may have a diffusion optical element maximum density value P1 at a position corresponding to the sum d3 of the light guide plate 15.

This is because as light emitted from the light sources 13 may pass through the light guide plate 15 toward the front side of the light guide plate 15, the light may be diffused to be decreased in brightness per area (i.e., in luminance per area). Thus, light may be maximally diffused at the front end of the light guide plate 15 along the sum d3.

Referring to FIGS. 7, 8 and 11, an additional optical element density distribution curve C2 of the additional optical elements provided to the diffusion optical element region R2 may be plotted.

The additional optical element density distribution curve C2 may have an additional optical element maximum density value P2 at the rear end of the light guide plate 15, and may decrease non-linearly in density value to have zero at a position where the diffusion optical element region R2 ends along the distance d6.

The additional optical element maximum density value P2 may be less than the diffusion optical element maximum density value P1.

In the rear end of the light guide plate 15 where the diffusion optical element region R2 starts, a portion of the rear end contacting the region corresponding to the second distance w2 may be less than the other portions of the rear end in luminance, and light spread in the light guide plate 15 may be increased forward. Thus, the region of the light guide plate 15 where the diffusion optical element region R2 is provided may increase in luminance forward.

The additional optical element density distribution curve C2 of the diffusion optical element region R2 may decrease in optical element density forward.

A total optical element density distribution curve c3 of the lower surface 154 in the state where the diffusion optical element region R1 overlaps the diffusion optical element region R2 may now be described.

Referring to FIGS. 7, 8 and 12, the total optical element density distribution curve c3 in the region where the diffusion optical element region R1 overlaps the diffusion optical element region R2 may be plotted.

The total optical element density distribution curve c3 may be formed by combining the diffusion optical element density distribution curve C1 and the additional optical element density distribution curve C2.

An initial value of the total optical element density distribution curve c3 may be equal to the additional optical element maximum density value P2. In the total optical element density distribution curve c3, a component corresponding to the additional optical element density distribution curve C2 may be dominant until arriving at the position where the light incident part 15b is in contact with the light emitting part 15a along the distance d1, and the diffusion optical element density may be relatively low.

That is, the total pattern optical element distribution curve c3 may decrease in optical element density from the additional optical element maximum density value P2 until arriving at the position corresponding to the distance d1, and may increase in optical element density from the position corresponding to the distance d1 since the diffusion optical element density distribution curve C1 is dominant.

The total optical element density distribution curve c3 may be the same as the diffusion optical element density distribution curve C1 from the position where the diffusion optical element region R2 ends along the distance d6, and may have the maximum value, equal to the diffusion optical element maximum density value P1, at the front end of the light guide plate 15 corresponding to the sum d3.

That is, when the diffusion optical element region R1 is provided regardless of the first distance w1 and the second distance w2 between the light sources 13, the additional optical element regions R2 may be selectively added according to the first distance w1 and the second distance w2 between the light sources 13 so as to compensate for uneven luminance distribution due to difference between the first distance w1 and the second distance w2.

According to the embodiment, the module-type backlight unit may include the light guide plates ide light to the display panel. The thickness of the display apparatus may be decreased, and contrast of a display image may be improved using an entire driving method or a local driving method such as the local dimming method and the impulsive method.

Since the backlight unit is driven using the local dimming method, an entire power consumption of the display apparatus may be reduced.

In addition, when the distances between the light sources are different from each other, and not the same, an uneven luminance distribution of the light guide plate due to the difference between the distances between the light sources may be prevented.

The diffusion optical elements and the diffusion optical element region R1 may be referred to as a first optical element and a first optical element region, respectively. The additional optical element and the additional optical element region R2 may be referred to as a second optical element and a second optical element region, respectively.

Although the diffusion optical element (i.e., the first optical element) overlaps the additional optical element (i.e., the second optical element), only the additional optical element may be provided at a position of the light emitting part 15a corresponding to the second distance w2, without the diffusion optical element.

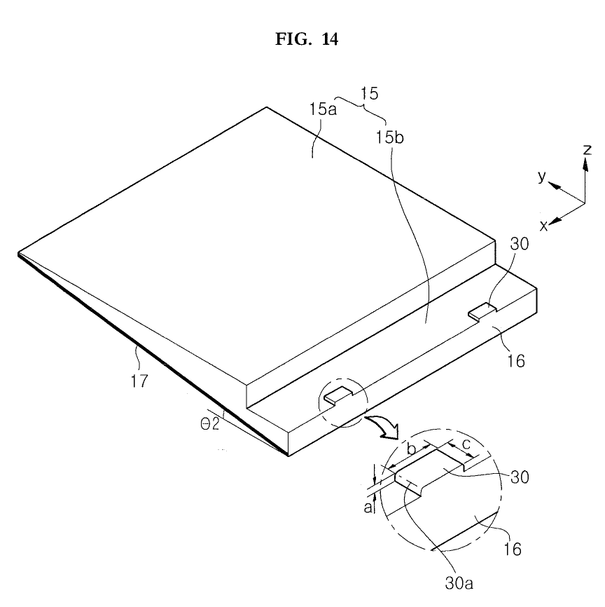

FIG. 13 is a cross-sectional view illustrating a backlight unit according to an embodiment. FIG. 14 is a perspective view illustrating the light guide plate 15 of FIG. 13. Other embodiments and configurations may also be provided.

In FIGS. 13 and 14, a description of similar parts as in FIGS. 1 to 12 may be omitted.

Referring to FIGS. 13 and 14, the optical assembly 10 may include the light source 13, the light guide plate 15, the reflecting member 17, and a side cover 20 for fixing or attaching the light source 13 and the light guide plate 15.

The side cover 20 may provide a fixing position with respect to the bottom cover 110 and surround the light source 13 and a portion of the light guide plate 15. The light source 13 may be provided in the side cover 20.

The side cover 20 may include a first side cover 21 provided on the light source 13 and the light incident part 15b of the light guide plate 15, and a second side cover 22 provided under the light incident part 15b. The side cover 20 may be formed of plastic or metal.

The first side cover 21 may be coupled to the second side cover 22 through a first fixing member 51 to prevent the shaking of the light source 13 and the light guide plate 15 due to external shock, and more particularly to prevent the shaking along the second direction (z-axis).

The second side cover 22 may support the inclined surface of the light guide plate 15 to firmly maintain alignment of the light guide plate 15 with the light source 13 and protect the light guide plate 15 and the light source 13 from external shock.

The light incident part 15b of the light guide plate 15 may include a protrusion 30 protruding with a predetermined height ‘a’. The protrusion 30 may be provided to at least two points in the x-axis direction on the upper surface of the light incident part 15b of the light guide plate 15.

The shape of the protrusion 30 may vary. For example, the protrusion 30 may have a rectangular parallelepiped shape. The protrusions 30 may be caught by the first side cover 21 to prevent the shaking of the light guide plate 15 along the x-axis and the y-axis.

An edge 30a of the protrusion 30 may be rounded to prevent a case that a crack is formed at the protrusion 30 by shock due to movement of the light guide plate 15.

The height ‘a’ of the protrusion 30 may range from about 0.3 mm to 0.6 mm from the upper surface of the light incident part 15b. The protrusion 30 may have a width ‘b’ ranging from about 2 mm to 5 mm along the x-axis. The protrusion 30 may have a width ‘c’ ranging from about 1 to 3 mm along the y-axis.

The protrusion 30 may be provided between neighboring LEDs 11 and adjacent to a light incident surface 16 on the upper surface of the light incident part 15b so as to prevent optical interference of light emitted from the LEDs 11 due to the protrusion 30 integrally formed with the light guide plate 15.

The LEDs 11 may be spaced a predetermined distance from each other. The LEDs 11 may be provided in an oblique direction with respect to the protrusion 30 to minimize optical effect due to the protrusion 30 of the light guide plate 15. Accordingly, the distance between the LEDs 11 around the protrusion 30 may be greater than the distance between the other LEDs 11.

The distance between a portion of the LEDs 11 may be greater than the distance between the other LEDs 11 to secure a coupling space of the first side cover 21 and the second side cover 22 and minimize optical effect due to coupling force for pressing the light guide plate 15.

The first side cover 21 may have first holes 41 at positions corresponding to the protrusions 30 of the light incident part 15b.

The first holes 41 may be larger than the protrusions 30 such that the protrusions 30 are fitted and caught to the first holes 41. The protrusion 30 provided in the first hole 41 may partially have a predetermined gap that may be a margin for preventing torsion of the light guide plate 15 when the light guide plate 15 is expanded by environmental change such as a sharp temperature increase. In this case, the rest of the protrusion 30 without the predetermined gap may be in contact with the first side cover 21 to increase fixing force thereof.

At least one second hole 42 may be further provided in the first side cover 21. The second side cover 22 may have at least one third hole 43 at a position corresponding to the second hole 42.

The backlight unit 100 as described above may be provided in the bottom cover 110 having a box shape with an open top.

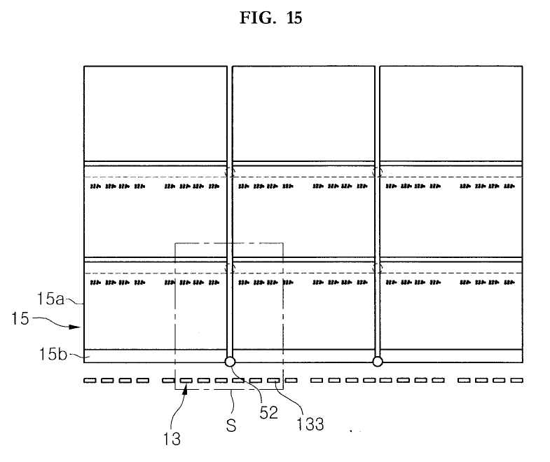

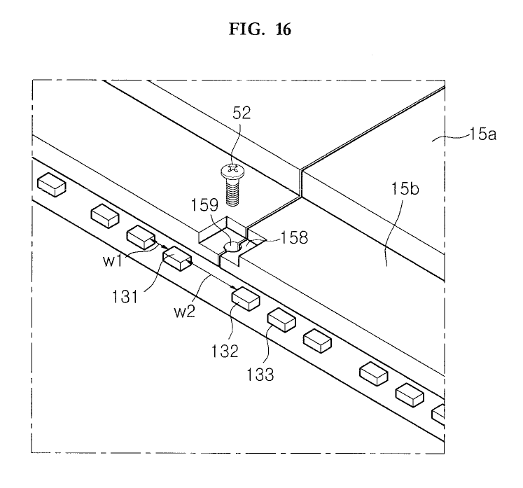

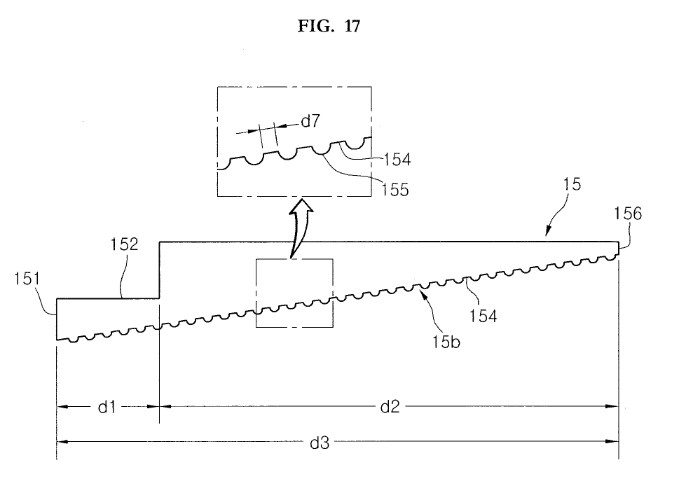

FIG. 15 is a plan view illustrating the backlight unit 100 according to an embodiment. FIG. 16 is an enlarged view illustrating a portion S of FIG. 15. Other embodiments and configurations may also be provided.

The current embodiment is the same as the embodiment of FIG. 6 except for a structure configured to fix or attach the light guide plate 15, which may be further described.

Referring to FIGS. 15 and 16, the backlight unit 100 may include a fixing member 52 that is configured to simultaneously fix or attach the adjacent light guide plates 15 to a bottom cover.

More particularly, the light incident parts 15b adjacent to each other may be respectively provided with recesses 158 that are symmetric to each other.

One of the light guide plates 15 may be referred to as a first light guide plate, and another one may be referred to as a second light guide plate.

When the recesses 158 of the light incident parts 15b are adjacent to each other, the width of the recesses 158 may be greater than the width of a head of the fixing member 52.

The height of the head may be less than or equal to the depth of the recess 158 (i.e., a distance between the upper surface of the light incident part 15b and a surface of the recess 158). This may prevent the head from protruding out of the recess 158.

The fixing member 52 may be a cover member that covers at least one portion of the light incident part 15b.

The recesses 158 may be provided with a through hole 159 through which a portion of the fixing member 52 may pass.

When the light guide plates 15 are adjacent to each other, the fixing member 52 may be inserted into the through hole 159 defined by the light guide plates 15, and may be fixed or attached to the bottom cover. The head of the fixing member 52 may be provided at the recesses 158 to simultaneously press the light guide plates 15 to the bottom cover so that the fixing member 52 fixes or attaches the light guide plates 15 to the bottom cover.

The recess 158 provided in the first light guide plate 15 may be referred to as a first insertion part, and the recess 158 provided in the second light guide plate 15 may be referred to as a second insertion part.

The distance between a first light source 131 provided at a first end of the light guide plate 15 in the left-and-right direction and a second light source 132 adjacent to the first light source 131 and provided at a second end of the adjacent light guide plate 15 in the left-and-right direction may be equal to the second distance w2.

The second light source 132 and a third light source 133, which are adjacent to each other at the light guide plate 15 in the left-and-right direction, may be spaced apart from each other by the first distance w1.

The second distance w2 may be greater than the first distance w1 as described with respect to FIG. 7.

That is, since the structure for fixing or attaching the light guide plates 15 (i.e., the fixing member 52) is provided at the position where the light guide plates 15 are adjacent to each other, the first light source 131 and the second light source 132 may be spaced the second distance w2, which is greater than the first distance w1, from each other to secure the space where the fixing member 52 is provided.

Accordingly, an optical element structure for compensating for uneven luminance distribution due to difference between the first distance w1 and the second distance w2 may be the same as FIG. 8. Thus, a description thereof will be omitted.

FIG. 17 is a cross-sectional view of a light guide plate according to an embodiment. Other embodiments and configurations may also be provided.

The FIG. 17 embodiment may be similar to the FIG. 6 embodiment except for a scattering-mechanism formed on the bottom surface 154 (or lower surface) of the light guide plate 15, as will be further described.

As shown in FIG. 17, a scattering-mechanism, which is an optical element 155, may be formed in protruding shapes on the bottom surface 154 of the light guide plate 15.

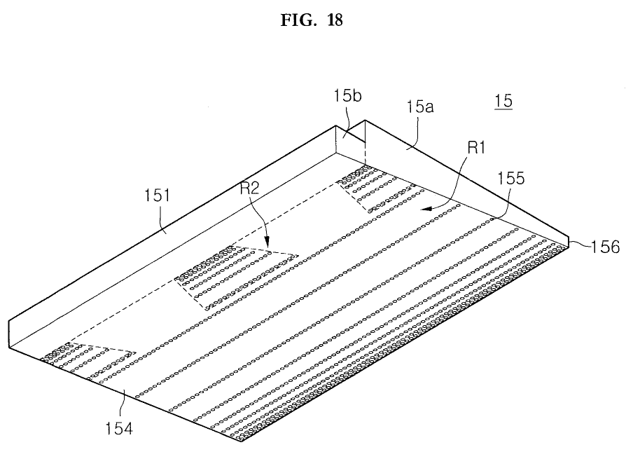

FIG. 18 is a perspective view illustrating a bottom surface of a light guide plate according to an embodiment. Other embodiments and configurations may also be provided.

The FIG. 18 embodiment may be the same as the FIG. 6 embodiment except for a scattering-mechanism formed on the bottom surface 154 of the light guide plate 15, as may be further described.

As shown in FIG. 18, an diffusion optical element region R2 may start from the side of the light incident part 15b (i.e., adjacent to the light emitting part 15a) and may be elongated with a predetermined length in the first direction.

Thus, any optical elements 155 or scattering-mechanisms may not be formed on a part of the bottom surface 154 (i.e., corresponding to the light emitting part 15a), and the optical elements or scattering-mechanism may just be provided on the other part of the bottom surface 154 (i.e., corresponding to the light incident part 15b).

According to the above described embodiments, a module-type backlight unit may include the light guide plates that provide light to the display panel. A thickness of the display apparatus may be decreased, and contrast of a display image may be improved using the entire driving method or the local driving method such as the local dimming method and the impulsive method.

Since the backlight unit is driven using the local dimming method, an entire power consumption of the display apparatus may be reduced.

In addition, when distances between the light sources are different from each other, and not the same, an uneven luminance distribution of the light guide plate due to difference between the distances may be prevented.

Embodiments may provide a backlight unit and a display apparatus including the backlight unit to improve quality of a display image.

In one embodiment, a backlight unit may include a substrate and a plurality of light sources arrayed on the substrate, the light sources emitting light with a predetermined orientation angle with respect to a first direction, the light sources including first through third light sources adjacent to each other. The backlight unit may further include a light guide plate including: a light incident part having a light incident surface to which streaks of light respectively emitted from the light sources are laterally incident, and a light emitting part emitting the incident streaks of light upward and having a side adjacent and connected to the light incident part. A first distance between the first light source and the second light source is less than a second distance between the second light source and the third light source.

In another embodiment, a backlight unit may include a bottom cover, a substrate at the bottom cover, a plurality of light sources arrayed on the substrate, the light sources emitting light with a predetermined orientation angle with respect to a first direction, the light sources including first through third light sources adjacent to each other. The backlight unit may further include N (N is 2 or greater) light guide plates including: a light incident part having a light incident surface to which streaks of light respectively emitted from the light sources are laterally incident, and a light emitting part emitting the incident streaks of light upward and having a side adjacent and connected to the light incident part. The light emitting part of a K^{th} (K is one of 1 to N−1) light guide plate of the N light guide plates may have a distant end from the light incident part, and the distant end may be provided on an upper side of the light incident part of a K+1^{th} light guide plate. A first distance between the first light source and the second light source may be less than a second distance between the second light source and the third light source.

In another embodiment, a display apparatus may include a display panel, a backlight unit on a rear side of the display panel, the backlight unit including a plurality of driving areas that are independently drivable, and a driving part on a rear side of the backlight unit, the driving part driving at least one of the display panel and the backlight unit. The backlight unit may includes a bottom cover, a substrate at the bottom cover, and a plurality of light sources arrayed on the substrate, the light sources emitting light with a predetermined orientation angle with respect to a first direction, the light sources including first through third light sources adjacent to each other. The backlight unit may further include a light guide plate including: a light incident part having a light incident surface to which streaks of light respectively emitted from the light sources are laterally incident, and a light emitting part emitting the incident streaks of light upward and having a side adjacent and connected to the light incident part. A first distance between the first light source and a second light source is less than a second distance between the second light source and a third light source

A backlight unit comprises: at least one light guide plate having a light incident part to receive light from a first direction and a light emitting part adjacent to the light incident part to emit light received from the light incident section in a second direction, the first and second directions being different directions, a first portion of the light emitting part closer to the light incident part in the first direction has a first prescribed thickness, and a second portion of the light emitting part farther from the light incident section in the first direction has a second prescribed thickness, the first prescribed thickness being different from the second prescribed thickness; and a plurality of light sources arranged in a third direction, the light sources configured to emit light toward the first direction, the light sources including a first light source, a second light source and a third light source, wherein the second light source is adjacent to the first light source and the third light source, wherein a first distance between the first light source and the second light source is different from a second distance between the second light source and the third light source. A backlight unit comprises: at least one light guide plate having a light incident part to receive light from a first direction and a light emitting part adjacent to the light incident part to emit light received from the light incident section in a second direction, the first and second directions being different directions, a lower surface of the light incident part having a first plurality of optical elements and a lower surface of the light emitting part having a second plurality of optical elements; and a plurality of light sources in a third direction, the light sources configured to emit light toward the first direction.

A display apparatus having the backlight unit of above, wherein the display apparatus comprises: a display panel; and a driving circuit to drive at least one of the display panel or the backlight unit, the backlight unit provided between the display panel and the driving circuit. The N×M array of light guide plates is divided into a plurality of areas, the light guide plates in at least one area emit light independently from the light guide plates in at least one other area such that a brightness of the at least one area is different from brightness of the at least one other area.

The present disclosure also provides a “green” technology for display devices. Presently, the backlight is generally turned on continuously, even when the display of the entire screen is not desirable. For example, the prior art display allows control of the resolution of the entire display screen but not the size of the display screen. However, in certain instances, a smaller screen area may be desirable for lower resolution images. The size of the display area can be controlled based on the present disclosure. For example, instead of viewing images and programs in 42 inch display, the display screen size can be reduce to 32 inches by turning off the light sources for appropriate number of light guide plates located at the periphery of the display device. As can be appreciated, the location and size of the display area can be controlled based on program or user needs. As can be appreciated, multiple configuration may be possible based on turning on or off the light sources for appropriate number of light guide plates (light guide panels or light guide modules or assemblies) based on application and user configuration.

This application is related to Korean Applications Nos. 10-2008-0049146 filed on May 27, 2008, 10-2008-0061487 filed on Jun. 27, 2008, 10-2008-0099569 filed on Oct. 10, 2008, 10-2009-0035029 filed on April 22, 200910-2009-0036472 filed Apr. 27, 2009, 10-2009-0052805 filed on Jun. 15, 2009, 10-2009-0061219 filed Jul. 6, 2009, 10-2009-0071111 filed Aug. 2, 2009, 10-2009-0072449 filed Aug. 6, 2009, 10-2009-0075120 filed on Aug. 14, 2009, 10-2009-0098844 filed on Oct. 16, 2009, and 10-2009-0098901 filed on Oct. 16, 2009, whose entire disclosures are incorporated herein by reference. Further, this application is related to U.S. Provisional Patent Application Nos. 61/219,480 filed on Jun. 23, 2009; 61/229,854 filed on Jul. 30, 2009; 61/230,844 filed on Aug. 3, 2009; and 61/233,890 filed on Aug. 14, 2009 and U.S. application Ser. Nos. 12/453,885 filed on May 22, 2009, 12/618,603 filed on Nov. 13, 2009, 12/632,694 filed on Dec. 7, 2009, and LGE-162, LGE-163, HI-0400, HI-0412, HI-0413, HI416 and HI-0420 all filed on Mar. 19, 2010, whose entire disclosures are incorporated herein by reference.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A backlight unit comprising:
at least one light guide plate having a light incident part to receive light from a first direction and a light emitting part adjacent to the light incident part to emit light received from the light incident section in a second direction, the first and second directions being different directions, a first portion of the light emitting part closer to the light incident part in the first direction has a first prescribed thickness, and a second portion of the light emitting part farther from the light incident section in the first direction has a second prescribed thickness, the first prescribed thickness being different from the second prescribed thickness; and
a plurality of light sources arranged in a third direction, the light sources configured to emit light toward the first direction, the light sources including a first light source, a second light source and a third light source, wherein the second light source is adjacent to the first light source and the third light source,
wherein a first distance between the first light source and the second light source is different from a second distance between the second light source and the third light source.

2. The backlight unit according to claim 1, wherein a lower surface of the light incident part includes a first region having a plurality of optical elements.

3. The backlight unit according to claim 2, wherein a width of the first region in the third direction changes in the first direction.

4. The backlight unit according to claim 2, wherein there is a change in a density of the optical elements.

5. The backlight unit according to claim 4, wherein the density of the plurality of optical elements decreases in the first direction.

6. The backlight unit according to claim 2, wherein a portion of the first region nearest to one of the light sources has a width that is equal to or greater than the second distance.

7. The backlight unit according to claim 6, wherein the second distance is greater than the first distance.

8. The backlight unit according to claim 2, wherein the first region extends into the a portion of a lower surface of the light emitting part.

9. The backlight unit according to claim 2, wherein the optical elements are formed in relief or intaglio on the lower surface of the light guide plate.

10. The backlight unit of claim 2, wherein the lower surface of the light incident part, near or at sides of the at least one light guide plate, includes second and third regions having the plurality of optical elements.

11. The backlight unit of claim 1, wherein a lower surface of the light emitting part includes a plurality of optical elements.

12. The backlight unit of claim 11, wherein there is a change in density of the optical elements along the first direction.

13. The backlight unit of claim 12, wherein the density increases such that the density of optical elements on the lower surface of the first portion is less than the density of optical elements on the lower surface of the second portion.

14. The backlight unit according to claim 1, wherein the substrate includes a hole between the second light source and the third light source.

15. The backlight unit according to claim 1, wherein the at least one light guide plate includes a plurality of light guide plates, and a number of the light guide plates in the first direction is N, wherein N is 2 or greater, and a portion the light emitting part of a K^{th} (K is one of 1 to N−1) light guide plate overlaps a portion of the of the light incident part of a K+1^{th} light guide plate.

16. The backlight unit of claim 1, wherein a number of light guide plates in a third direction is M such that the plurality of light guide plates are arranged in an N×M array.

17. A display apparatus having the backlight unit according to claim 16, wherein the display apparatus comprises:
a display panel;
a driving circuit to drive at least one of the display panel or the backlight unit, the backlight unit provided between the display panel and the driving circuit.

18. The display apparatus of claim 17, wherein the N×M array is divided into a plurality of areas, the light guide plates in at least one area emit light independently from the light guide plates in at least one other area such that a brightness of the at least one area is different from brightness of the at least one other area.

19. A backlight unit comprising:
at least one light guide plate having a light incident part to receive light from a first direction and a light emitting part adjacent to the light incident part to emit light received from the light incident section in a second direction, the first and second directions being different directions, a lower surface of the light incident part having a first plurality of optical elements and a lower surface of the light emitting part having a second plurality of optical elements; and
a plurality of light sources in a third direction, the light sources configured to emit light toward the first direction.
